(19) United States
(12) Patent Application Publication
(10) Pub. No.: US 2021/0250194 A1
(43) Pub. Date: Aug. 12, 2021

(54) PERSONAL CALENDAR BRIDGE FOR ROOM-BASED CONFERENCING

(71) Applicant: Mersive Technologies, Inc., Denver, CO (US)

(72) Inventors: Christopher Jaynes, Denver, CO (US); Ryan Lee, Highlands Ranch, CO (US)

(21) Appl. No.: 17/170,753

(22) Filed: Feb. 8, 2021

Related U.S. Application Data
(60) Provisional application No. 62/971,940, filed on Feb. 8, 2020.

(51) Int. Cl. H04L 12/18; H04N 7/15

(52) U.S. Cl. CPC H04L 12/1818; H04N 7/155; H04L 12/1822

(57) ABSTRACT

A video conferencing room system and method may use a room calendar and a bridge to a personal calendar on a client device so a user may start a meeting in a video conferencing room without scheduling access to the room in advance. Further, the video conferencing room system may be used with video conferencing software running on the client device instead of the video conferencing room system. The room is equipped with a host controller connected to a display, camera, audio and/r other infrastructure in the room for running a video conference. A calendar parser identifies meeting calendar entries and determines meeting metadata. A room manager may facilitate a video conference and inform attendees.

### BACKGROUND

Video conferencing room systems are configured and deployed so that users can leverage infrastructure to work with remote participants in a video conference meeting. Typically, a video conferencing room system includes infrastructure such as some or all of a shared display, a camera, an audio system, and an in-room interface. The room camera typically has a wide field of view and is deployed in a fixed location to support teams of users in the room who want to participate in the meeting. The audio system may include a microphone, speakers or telephone. A physical space occupied by a business or organization may include more than one conference room outfitted with a video conferencing room system.

The in-room interface is connected to the room infrastructure and provides an access point for controlling the room infrastructure as well as applications, such as Zoom, Teams or WebEx, for running a video conference meeting with remote participants. It may also be connected to a network for managing call control (via SIP), audio, and video send (RSTP). The in-room interface may be a dedicated tablet or a host controller, for example.

Users of a video conferencing room system log into or otherwise access the in-room interface. The in-room interface presents a user interface for starting/stopping a video conference, enabling/disabling video, and enabling/disabling content sharing. The controls are presented in the room—typically through a touch panel or a similar device.

There are several challenges with hosting a video conference meeting using current video conferencing room systems. First, users scheduling a video conference meeting must remember to include the room itself in the invitation. This ensures that the room is aware of the upcoming meeting and can then join the meeting to allow use of the video conferencing room system, for example, to present the camera and audio inputs into the meeting. Since the room must be invited ahead of time, users must schedule the room in advance and cannot simply “find an open room”.

Because video conferencing room systems in a physical space of a business or organization are often a shared resource between multiple users, they are typically scheduled for use through a calendaring system maintained by the business or organization on a server and/or in cloud storage. Furthermore, because video conferencing room systems are tied to a specific video conferencing application, the room itself is invited to the meeting as an “attendee.” This is a significant tradeoff, forcing users to choose between a one-touch start experience for their users at the expense and complexity of only supporting meeting specific to a certain vendor (WebEx, Zoom, etc.)—This allows the room the support the meeting is specific ways; including a one-touch meeting start for an upcoming meeting (displayed on an interactive panel in the room), information about the upcoming call displayed on the room display (“Next Meeting Starts in 20 mins.)”. This ability is important enough that users will explicitly invite the room to video conferencing calls to gain these advantages. However, the user, or an administrator, is still required to actively start the meeting. Therefore, if a host, for example, is not at the meeting, the “one-touch” feature may be limited or otherwise useless.

This can be problematic—for example, the room will join the video conference as a “user” and this can be confusing to remote participants who aren't sure which of the participants in the meeting are individuals, and which represent a room that contains those individuals. Furthermore, an additional step in setting up the meeting is required to invite a room, and if a user forgets to invite the room she/he loses those capabilities. These are challenges for users who want to have a simple video conferencing experience without the additional complexity of inviting rooms to their meetings.

Another problem emerges when rooms are invited to a video conferencing call relation to how the meeting is controlled. Ambiguity can arise as to whether the video conference is controlled using the room controls or the host with her/his own device.

Current video conferencing systems may also create challenges for administrators. Prior art room systems are typically dedicated to certain video conferencing applications, and thus do not support accepting invites to any video conferencing calls, independently of the conferencing application specified in the invitation. To access video conference calls on non-dedicated video conferencing applications, if possible, an administrator is required to configure the room system to accept calls resulting in additional administrative overhead. Because there is additional overhead, typically room systems only support a single video conferencing application. This means if a user attempts to invite a room with a different application, it may not accept the meeting. Businesses or organizations that choose to provide multiple video conferencing applications must setup, manage, and pay for video conferencing accounts that can used by the room to join, which adds additional administrative burdens.

In addition, when a particular room must be equipped with a PC that is running the correct video conferencing software—for example if a user wants to add a call to a room using Zoom—the in-room interface must be capable of running Zoom software so it can accept the meeting and explicitly join using Zoom. This means users are forced to choose what applications their rooms will support ahead of time, for example, Zoom versus WebEx. Calls that are not supported simply won't work with the video conferencing room system. Each installed, the codec for a video conferencing application must be updated, managed and configured.

At the same time, the room system should still provide the advantages provided when the room was explicitly invited to the video conference. For example, the room should still be able to present the meeting title to participants on the room display (or an out of room panel), and should be able start the call automatically with a single button click “Start the next meeting”.

### SUMMARY

In an embodiment, a video conferencing room system enables a user to start a meeting in a conferencing-enabled room without scheduling access to the room in advance. This supports ad hoc meetings by allowing users to simply select a room from which to start a video conference on demand. It also simplifies the user experience, removing the burden of room scheduling ahead of time. Further, the video conferencing room system is software-agnostic. The room system presented here can be deployed without pre-selecting what video conferencing software will be used for meeting ahead of time. This allows the room to be used for any video conferencing software as the need arises. To achieve this, a user may start a meeting on their laptop or other computing device using their preferred application without being required to use a specific video conferencing application installed in the room. The room is equipped with a host controller that is connected to a display, camera, audio and other infrastructure in the room. A user device, such as a laptop, is running an application that has permission to read (and optionally write) to the user's calendar.

In another embodiment, the room system should still provide the advantages provided when the room was explicitly invited to the video conference. For example, the room should still be able to present the meeting title to participants on the room display (or an out of room panel), and should be able start the call automatically with a single button click “Start the next meeting.”

The users calendar may be stored on the device or elsewhere but is connected to the device through the network (i.e. a cloud calendaring solution).

### BRIEF DESCRIPTION OF THE DRAWINGS

FIG. 1 is a diagram illustrating exemplary components of the present system.

FIG. 2 is a more detailed view of the client device of FIG. 1.

FIG. 3 is a block diagram of a system for providing automatic in-room access to a meeting based on a calendar located on a client device, in an embodiment.

FIG. 4 is a flowchart illustrating a method for providing automatic in-room access to a meeting based on a calendar located on a client device, in an embodiment.

FIG. 5 is a flowchart of a method of resolving calendar conflicts in a video conferencing room, in embodiments.

### DETAILED DESCRIPTION

A video conferencing system includes a plurality of source computers connected to a collaboration session, with one or more media sources from at least one of the source computers may be displayed on a central shared display and on at least one of the source computers. A host controller provides an in-room interface and manages room infrastructure including the shared display, a camera and an audio system.

A video conferencing system may execute an application on the host controller to manage a video conference between users connected (wirelessly or via wired connection) with the room using their own devices (referred herein as a “client device,” “client display device”, or “user device”). In embodiments, a video conference may also be managed using an application on a user device. Further the user's calendar, or specific meeting information therefrom, on the user's device may captured at the user's device and transmitted to the host controller in-room system to 1) display information about the meeting, 2) launch the correct video conference on a host device and then connect it to the room and 3) even book the room using the calendar information from the user's calendar that was transmitted to the host controller.

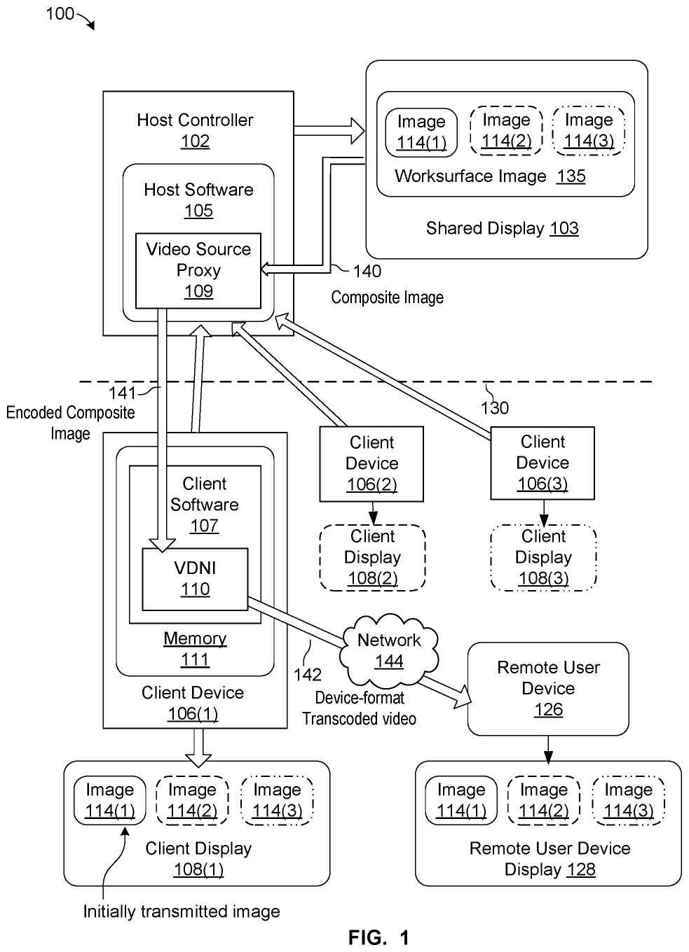

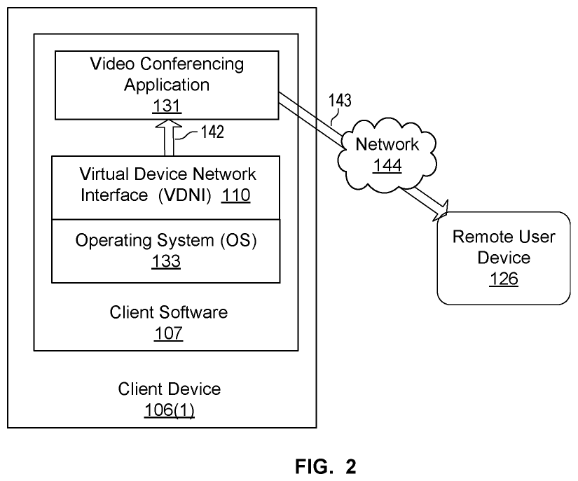

FIG. 1 shows exemplary components of a video conferencing room system 100. FIG. 2 shows a more detailed view of the client device of FIG. 1. FIGS. 1 and 2 are best viewed together in the following description. FIG. 1 illustrates a representative system, but principles disclosed herein are not limited to this implementation and may be implemented on a wide variety of video conferencing room systems with various infrastructure components interconnected in several ways. All or only certain portions of the system 100 may be used to implement the functionality described herein. System 100 includes a host controller 102 which communicates with one or more client devices 106 via a network 130, for example, a WAN, LAN or the Internet. As shown in FIG. 1, in an exemplary embodiment, host controller 102 includes host software 105, stored in an associated data storage (not shown). Host controller 104 may include a digital processor (not shown) that executes host software 105 to provide the functionality described herein. It should be appreciated that host software 105 and host controller 102 may be implemented using discrete logic circuits, or other form of firmware, software, or hardware, without departing from the scope hereof.

Host controller 102 is connected to shared display 103 and manages a collaborative work session between users of client devices 106. As shown, client device 106(1) may share image 114(1) as on shared display 103 as part of worksurface image 135 managed by host controller 102. Likewise, client device 106(2) shares image 114(2) and client device 106(3) shares image 114(3). Users may view worksurface image 135 on the host computer shared display 103 and may also view a version of worksurface image 135 on the display of their client device 106. Worksurface image 135 is stored in memory accessible to host controller 102. Although FIG. 1 shows each client device sharing a single image, which may represent any digital content, this is for purposes of illustration. Any client device may share multiple images or no images while still participating in a collaborative work session. Host software 105 including video source proxy 109 receives streams from client devices 106, sends them to shared display 103 and captures composite image 140 to send back to client devices 106.

Each client device 106 may be any type of computer-controlled device with a digital processor (not shown) and a display 108, such as a desktop or laptop computer, tablet, or smart phone, etc. Representative components are discussed for client device 106(1). A client software 107, resident in memory 111 in each client device 106, may be implemented as transitory or non-transitory computer readable instructions that, when executed by the digital processor implement the functionality and tasks as described in detail below. Client software 107 includes virtual device network interface (VDNI) 110. It should be appreciated that client software 107 and the digital processor may be implemented using discrete logic circuits, or other form of firmware, software, or hardware, without departing from the scope hereof.

As shown in FIG. 2, client device 106(1) includes client software 107, which includes an operating system (OS) 133, a virtual device network interface (VDNI) 110, and a video conferencing application 131.

Video conferencing application 131 is software (or discrete logic circuitry as discussed above) running on a client device 106 that is able to connect to a video conferencing service such as WebEx or Zoom and share various sources of the client device. These typically include the display, applications thereon, and one or more connected cameras of the given client device 106. A user operates video conferencing application 131 by selecting different sources to share as well as exercising other features common to video conferencing systems. By way of example, a user may initiate a call with a remote user device 126, type into a chat window, and activate a connected web camera to allow remote viewers to view the user. In embodiments, host controller 102 manages a collaborative work session with client devices 106 using host software 105 and client software 107 to exchange images, the composite work surface image and collaborative commands/metadata as needed. Video conferencing applications such as Zoom and WebEx only work with native devices of a client device and are not typically capable of receiving, for example, encoded composite worksurface image 141.

Embodiments discussed herein extend a video conferencing application at least by introducing a Virtual Device Network Interface (VDNI) 110, which is software, installed on a client device 106, that receives encoded composite image 141 from video source proxy 109 and presents itself to a video conferencing application 131 as a valid video source for video conferencing with remote user device 126. In one example, the VDNI 110 acts as a virtual camera, emulating a video (or other type of) camera device. A VDNI 110 may also emulate a virtual display. Either device will ‘appear’ to the host computer 102 as a physical device that has been plugged into the client device 106.

VDNI 110 an interface between a host controller 102 of the collaborative work session and a video conferencing endpoint, e.g., video conferencing application 131. The role of the VDNI 110 is to receive media frames (images or video) from the shared worksurface image 135 and to transcode (re-encode) that data into a video stream 142 into a format compliant with the video conferencing application 131. This video stream 142 acts as the content source of the device being emulated by the VDNI 110. For example, if the VDNI is acting as a virtual camera, the shared worksurface image 135 is received and encoded as a live video stream being captured by a simulated camera device.

Communication between the VDNI 110 and host controller 102 takes place over a network 130 and implements a protocol that allows the VDNI 110 to communicate directly with the host controller 102 of the sharing system. This allows the communication protocol between the host controller 102 and the VDNI 110 to be independent of the specific video conferencing endpoint being used on a client device 106(n). In embodiments, network 130 and network 144 may be the same or different networks.

Any video conferencing software running on a client computer that supports, for example, a video camera source, allows users to interact with the virtual camera to enable its video, select it as a source, and transmit that source to remote users who are connected in the video conferencing session.

A ‘Display Host-to-Client’ communications protocol manages client connections and transports image frame data displayed on the shared display 103 to a client device 106. It is used to encode a video stream, indicated by the arrow in FIG. 1. The client VDNI 110 receives this composite image 141 and converts it into a virtual video device protocol that represents a stream of images stored in a format that complies with existing video devices. For example, the Display Host-to-Client protocol may include partial frames as the host/client communicates over the network. 130. These frames can be buffered and then transcoded into a standard video stream (i.e., H.264) presented according to a known device driver format to the client software 107. Another protocol is employed to receive the transcoded VDNI data (indicated by arrow 143 in FIG. 2) and send it over a network 144, to remote user device 126, using video conferencing standards. Well-known methods are employed for the various protocol conversions used in the present system.

The system described above is representative of a video conferencing system according to an embodiment. In other embodiments, components may be added or deleted from the system as described, networking connections may change according to interconnected processing components. Further, any individual client device 106 may be located in a different physical location than host controller 102 and the other room infrastructure.

In an embodiment, a host controller in a video conferencing room has access to a calendar service that maintains a calendar of meetings, or video conferences scheduled for the room. This calendar may be installed in the host controller directly or indirectly accessed through an external server. Further, a calendar parsing service may receive a current calendar entry including a date and time, then produce meeting metadata that will be transmitted to a client device 106.

In an embodiment, meeting metadata may specify a vendor, meeting start time, meeting end time, and a link to join the meeting. The meeting metadata may further include a pin code or line-in information.

After parsing a calendar entry, the host controller may cause the shared display to display information that informs users to plug into (or otherwise wirelessly connect to) the host controller based on this calendar information (for example, “Welcome to your WebEx Meeting starting in 5 mins, please connect to host controller to begin”).

In embodiments, a personal calendar bridge for room-based conferencing allows a user to schedule a meeting on a calendar on a personal device and specify attendees without specifying a particular, or any, video conference room. A user may access a video conferencing room without scheduling use of the room in advance, i.e., there is no pre-existing calendar entry for the room. In these embodiments, a user has the flexibility of entering any available video conferencing room that is not in use and starting a conference using a video conferencing application on the user's device.

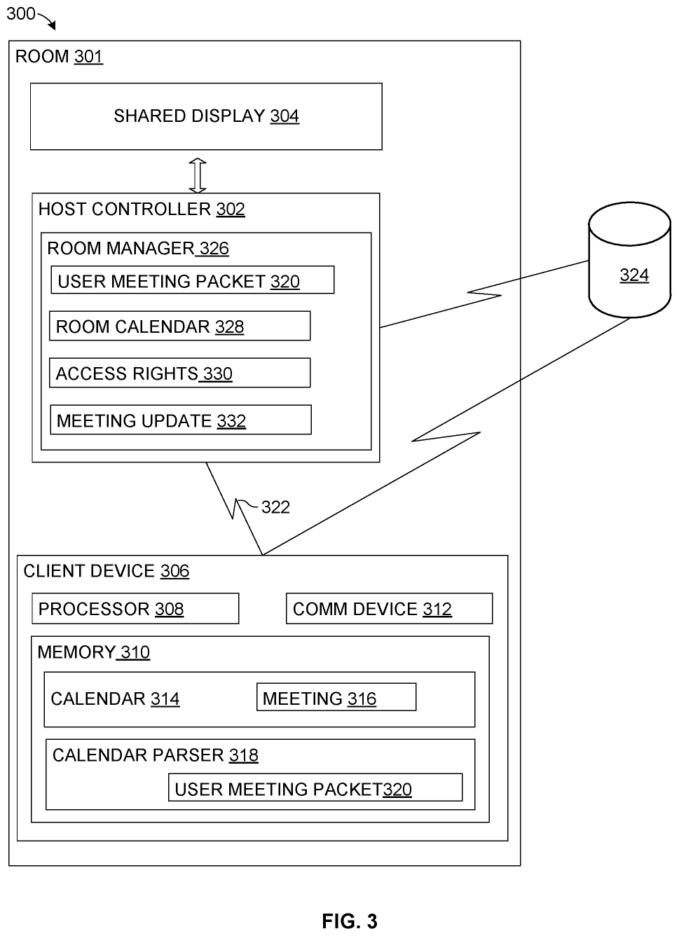

FIG. 3 is a block diagram of a system 300 for providing automatic in-room access to a meeting based on a calendar located on a client device, in an embodiment. System 300 includes a host controller 302 connected (via wireless or wired connection) to a shared display 304. Host controller 302 and the shared display 304 are located in room 301. In embodiments, host controller 302 and shared display 304 are dedicated video conferencing infrastructure for room 301. In embodiments, host controller 302 includes one or more of the features of host controller 102 discussed above. An example of the host controller 302 is the Solstice Pod sold by Mersive Technologies, Inc. In embodiments, shared display 304 includes one or more of the features of shared display 103 discussed above. Therefore, the functionality of the host controller 302 and shared display 304 discussed herein may be in addition to, or entirely separate from any one or more of the functionalities capable of the host controller 102 and shared display 103, respectively, as discussed above.

System 300 also includes a client device 306. In embodiments, the client device 306 includes one or more of the features of client device 106 discussed above. Therefore, the functionality of the client device 306 discussed herein may be in addition to, or entirely separate from any one or more of the functionalities capable of the client device 106 discussed above. The client device 306 may be used by a user to connect, via wired or wireless connection, to host controller 302 to utilize the conferencing capabilities provided by the host controller 302 and the shared display 304 for room 301. The client device 306 may automatically connect to the host controller 302, for example via occupancy detection, may manually connect to the host controller 302 via input of a code (e.g., randomly generated code, password, URL, or any other identifier associated with the host controller 302) into an application associated with the host controller 302 on the client device. may be plugged into the host controller 102, or any other connection technique known in the art.

The client device 306 includes one or more processor 308, memory 310, and communication device 312. The memory 310 may store a calendar 314 having one or more meetings 316 therein. Calendar 314 is any calendar application known in the art, for example Outlook® calendar, Asana calendar, Google calendar, etc. The calendar 314 may also be a web-based calendar system where user credentials are required to access the calendar 314.

Client device 306 further includes a calendar parser 318 stored in the memory 310. The calendar parser 318 includes computer readable instructions that when executed by the one or more processor 308 cause the client device 306 to implement the following functionality. Calendar parser 318 accesses calendar 314 and identifies one or more meetings 316 therein. The calendar parser 318 may access all data within calendar 314, or may be limited to accessing only data within a given time window (e.g., 1 hour prior to and after a given access time, the current day, the current week, the current month, the current year, etc.). If credentials to access a given calendar are needed, the calendar parser 318 may automatically enter them (if stored in memory), or may prompt the user of client device 306 to provide such credentials. In embodiments, calendar parser 318 may also be implemented on server 324 host controller 302. Calendar parsing functions may be provided as part of room manager 326, for example.

The calendar parser 318 generates a user meeting packet 320. The user meeting packet 320 includes metadata defining one or more of the meetings 316 extracted from the calendar 314 by the calendar parser 318. The metadata includes any information of the extracted meeting 316 desired, such as but not limited to meeting title, meeting date, meeting time, meeting organizer, meeting host, meeting participants, meeting members (organizer/host/participates) contact information, meeting application and connection requirements (e.g., Zoom, BlueJeans, Google Hangout, meeting equipment requirements (e.g., phone/phone number, video requirements, etc.) and other information known in the art. User meeting packet 320 is then transmitted via the communication device 312 and a communication link 322 (hardwired or wireless) to the host controller 302 from the client device 306. In embodiments, the user meeting packet 320 is additionally or alternatively transmitted, either directly from the client device 306, or relayed from the host controller 302, to a server 324 that is externally located from the room 301. The server 324 may function as a room management server that controls meetings across multiple rooms for a given organization, building, entity, etc. In embodiments where calendar parser 318 is implemented on server 324 or host controller 302, user meeting packet 320 may include a calendar notice that is parsed to determine meeting metadata on server 324 or host controller 302 instead of on client device 306.

The host controller 302 includes a room manager 326. The room manager 326 comprises computer readable instructions stored in memory of the host controller 302 that when executed by at least one processor of the host controller 302 operates to control the room manager 326 to implement the following functionality. In embodiments, the room manager 326 is implemented at the server 324 as opposed to the host controller 302 such that any of the functionality, individually or collectively, described below is implemented by the server 324, or via collaboration between the server 324 and the host controller 302.

The room manager 326 receives the user meeting packet 320. The room manager 326 may control the shared display 304 to display information about the user meeting within the user meeting packet 320. In embodiments, room manager 326 may parse user meeting packet 320 to determine meeting metadata.

The room manager 326 may compare the metadata within the user meeting packet 320 to information associated with the room 301. For example, the room manager 326 may compare the meeting information in the metadata of the user meeting packet 320 (hereinafter the “user meeting”) to a room calendar 328 defining pre-scheduled meetings within room 301 (hereinafter referred to as a “room meeting”). If the user meeting matches the room meeting and said user meeting and room meeting are currently scheduled at the time of receipt of the user meeting packet 320 by the room manager 326, then the room manager 326 may automatically initiate the meeting defined in the user meeting packet 320. This automatic initiation may include transmitting a prompt to the client device 306 that, either automatically or after acceptance by the user of the client device 306, launches video conferencing application 131 on client device 306 then joins the appropriate call. The meeting, including any shared applications, screen shares, videos, etc. may be streamed from the client device 306 to the host controller 302 for display on the shared display 304 (and optional relay to other client devices that are either in the room connected to host controller 302, or wirelessly connected to the host controller 302 via a network.) In embodiments, room manager 326 may also use the metadata of the user meeting packet 320 to automatically launch the meeting on the host controller.

If a scheduling conflict exists between the user meeting and a room meeting, then the room manager 326 may resolve such scheduling conflict. For example, the room manager 326 may compare access rights 330 to the metadata in the user meeting packet 320 and determine if the client device 306 has appropriate access to reserve the room 301 and associated equipment therein.

As another example, to manage scheduling conflicts, the room manager 326 may transmit a message to the client device 306 indicating a meeting is already scheduled for the room, and the client device 306 cannot utilize the room equipment (such as the host controller 302 and the shared display).

As another example, the room manager 326 may analyze a facility-wide calendar (not shown) and transmit a message to the client device 306 including a list of other rooms that are available for immediate use, or available for use during a future meeting identified in the user meeting packet 320.

The room manager 326 may further analyze the metadata in the user meeting packet 320 to identify user information associated with the user meeting to identify if the user meeting has a higher priority than the pre-scheduled room meeting. For example, the room manager 326 may identify the user meeting has having precedence over a pre-scheduled room meeting when the user meeting includes a C-level or other higher priority attendee. For example, the room manager 326 may identify the user meeting has having precedence over a pre-scheduled room meeting when the user meeting has a higher number of participants (or a greater number of participants than a predetermined threshold). The room manager 326 may also ignore pre-scheduled meetings if the pre-scheduled meeting had previously started, but no activity had occurred on the host controller 302 or shared display associated with the pre-scheduled meeting.

The room manager 326 may also transmit the room calendar 328 to the client device 306 such that the user may interact with the client device 306 to schedule meetings in the room. In this way, a user simply needs to connect to the host controller 302, receive the room's calendar 328 and interact to reserve the room 301, and associated equipment.

The room manager 326 may further automatically update meeting participants. For example, when a user meeting did not previously identify room 301 for a given meeting, the room manager 326 (either from the host controller 302 or the server 324) may transmit a meeting update 332 (message, SMS, e-mail, etc.) to all participants identified in the user meeting packet 320 with the room information and associated connection information (e.g., one or more of dial-in information for the given meeting, and the URL and/or IP address of the host controller 302). The update may automatically change other participants calendars to reflect the room information and associated equipment connection information. Alternatively, the meeting update may be transmitted from the client device 306.

The above functionality of room manager 326 may be implemented for current meetings scheduled on the client device 106 calendar 314 when the client sends the user meeting packet 320 to the host controller 302. Additionally, or alternatively, the functionality discussed above of room manager 326 may be implemented for meetings 316 on the calendar 314 that are at a future date. For example, the user may enter a room 301 and automatically or otherwise manually connect to the host controller 302 and interact with the client device 306 to sync one or more future meetings with the host controller 302 to reserve the room 301 for future meetings. It should be appreciated that the user need not be in the room if the client device 306 is able to remotely connect to the host controller 302 (or server 324) remotely without being in room 301.

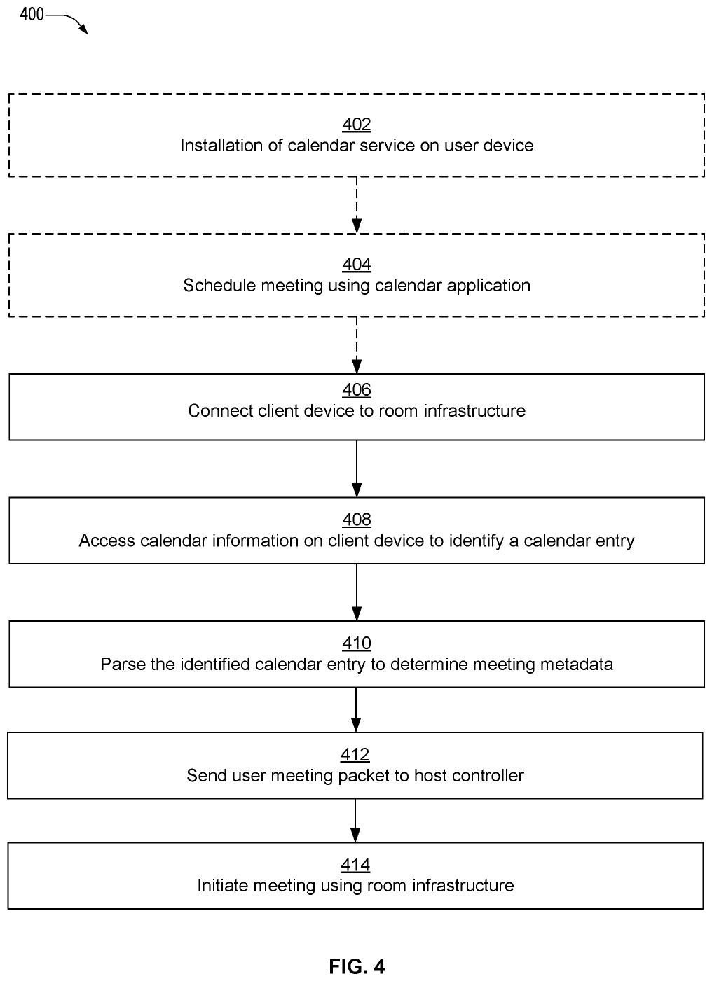

FIG. 4 is a flowchart illustrating a method 400 for providing automatic in-room access to a meeting based on a calendar located on a client device. Method 400 is implemented using the system 300, discussed above, for example, although other room conferencing systems may be used without departing from the scope hereof. Method 400 may include any one or more of the steps shown in FIG. 4, and not all steps are required to implement the method. Furthermore, the steps in FIG. 4 may be implemented in any order including those not shown.

Step 402 includes installing a calendar service on a client device. In an example of step 402, a calendar service is integrated with or given permission to access a calendar maintained on client device 306 and calendar 314 is maintained. The calendar service may be accessible through a click in the system tray of the client device 306, for example. Step 402 may include providing a calendar parser application (e.g., calendar parser 318) credentials for accessing the calendar on the client device 306, either automatically or in response to user interaction with the client device. In addition, in embodiments, step 402 may include storing a video conferencing application as executable instructions in a memory of the user's device. The application may be accessible through a shortcut on the desktop of the device.

Step 404 includes scheduling a meeting. In an example of step 404, a user schedules a meeting in a video conferencing room and using the calendar on the client device. In one example of step 404, the user interacts with client device 306 to schedule a meeting 316 and inputs any associated data required for the meeting such as but not limited to meeting title, meeting date, meeting time, meeting organizer, meeting host, meeting participants, meeting members (organizer/host/participates) contact information, meeting application and connection requirements (e.g., Zoom, BlueJeans, Google Hangout, meeting equipment requirements (e.g., phone/phone number, video requirements, etc.) and other information. In embodiments, this step also includes inviting additional participants. It may also include adding a specific video conferencing room to the meeting notice but this is optional.

Step 406 includes connecting a client device to the conferencing room infrastructure. In an example of step 406, a user interacts with the client device to connect the client device to a host controller associated with a video conferencing room. In an embodiment of step 406, the user interacts with the client device 306 to connect the client device 306 (via wired or wireless coupling) to the host controller 302. This step may be implemented using a video conferencing room system application (such as the Solstice application provided by Mersive Technologies, Inc., or another interface(s) such as a web interface) on the client device 306 that is compatible with the host controller 302. In embodiments, a user provides a room code associated with the video conferencing room 301 (or host controller 302) to the client device 306 which initiates connection between the client device 306 and the host controller 302. In another embodiment, a user may click or select the display name in a video conferencing room system application interface displayed on the client device 306. Alternatively, the host controller 302, or the client device 306, may detect presence of the client device 306 in room 301 and automatically connect client device 306 with host controller 302 (or other room infrastructure).

Step 408 includes parsing calendar information of the client device. In an example of step 408, calendar parser 318 is initiated in response to host controller 302 establishing a connection to client device 306 in step 406. Calendar parser 318 accesses calendar 314 and identifies one or more meetings 316 therein. Calendar parser 318 may access all data within calendar 314, or may be limited to accessing only data within a given time window (e.g., 1 hour prior to and after a given access time, the current day, the current week, the current month, the current year, etc.). If credentials to access a given calendar are needed, the calendar parser 318 may automatically enter them (if stored in memory), or may prompt the user of client device 306 to provide such credentials.

In step 410, the identified calendar entry is parsed to determine meeting metadata. In an example of step 410, calendar parser 318 determines meeting metadata of meeting 316 in the identified calendar entry. The metadata includes. but is not limited to meeting title, meeting date, meeting time, meeting organizer, meeting host, meeting participants, meeting members (organizer/host/participates) contact information, meeting application and connection requirements (e.g., Zoom, BlueJeans, Google Hangout, meeting equipment requirements (e.g., phone/phone number, video requirements, etc.) and other information known in the art. In embodiments, calendar parser 318 may also be implemented on server 324 host controller 302. Calendar parsing functions may be provided as part of room manager 326, for example.

In step 412, a user meeting packet is then transmitted to the host controller. In an example of step 412, user meeting packet 320 is sent to host controller 302 via communication device 312 and communication link 322 (hardwired or wireless). In embodiments, user meeting packet 320 is additionally or alternatively transmitted, either directly from the client device 306, or relayed from the host controller 302, to a server 324 that is externally located from room 301. Server 324 may function as a room management server that controls meetings across multiple rooms for a given organization, building, entity, etc. In embodiments where calendar parser 318 is implemented on server 324 or host controller 302, user meeting packet 320 may include a calendar notice that is parsed to determine meeting metadata on server 324 or host controller 302 instead of on client device 306.

Step 414 includes initiation of a meeting based on the client device calendar information. In an example of step 414, room manager 326 receives the user meeting packet 320 from the client device 306 and analyzes the metadata therein to initiate a meeting using the client device 306 and the room infrastructure (such as the host controller 302 and shared display 304). It should be appreciated that the initiated meeting need not use the shared display or video camera infrastructure, if not available in a given room or not required according to the metadata. Step 414 may further include transmitting a prompt from the host controller 302 (or server 324) to the client device 306 that either requests approval from the user to initiate the meeting, or controls the client device 306 to automatically execute the conferencing application, and/or join a conferencing call, associated with the meeting. In embodiments, a conferencing application uses artificial intelligence (AI) to recognize meeting invite patterns from a large database of meetings. In embodiments, the video conferencing room system application on client device 306 and on host controller 302 of the video conferencing room cooperatively use the metadata to automatically start the meeting, launch it on the user device, and then join the appropriate call.

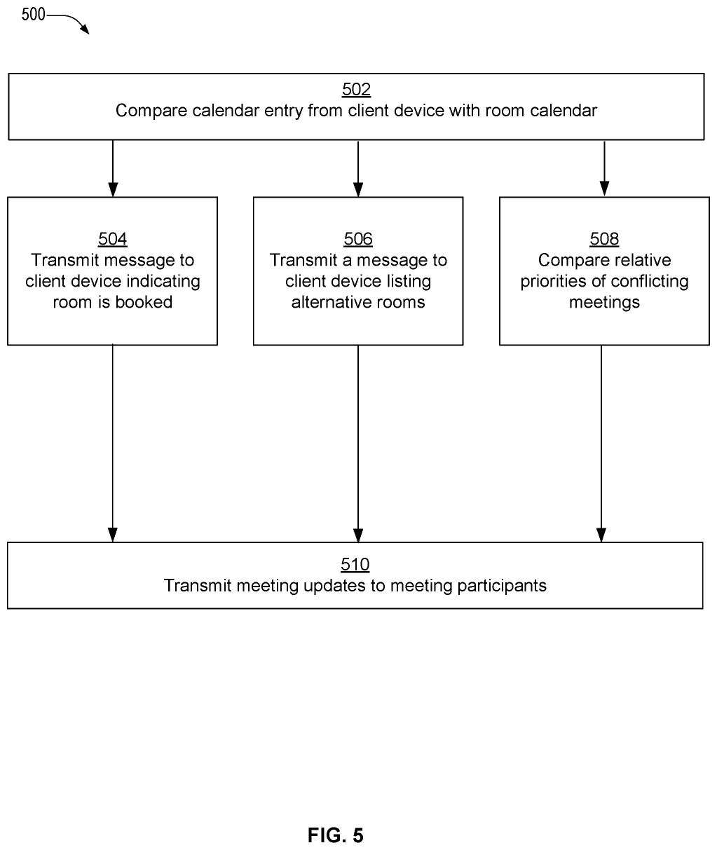

FIG. 5 is a flowchart illustrating a method 500 for resolving calendar conflicts in a video conferencing room. Method 500 is implemented using the system 300, discussed above, for example, although other room conferencing systems may be used without departing from the scope hereof. Method 500 may include any one or more of the steps shown in FIG. 5, and not all steps are required to implement the method. Any of the steps of method 500 may be implemented on the host controller 302, or server 324 or a combination thereof. The steps in FIG. 5 may be implemented in any order including those not shown.

Step 502 includes comparing a calendar entry from a client device with a calendar for a video conferencing room. In an example of step 502, room manager 326 may compare access rights 330 to the meeting metadata in the user meeting packet 320 and determine if the client device 306 has appropriate access to reserve the room 301 and associated equipment therein.

Step 504 includes detecting a conflict and sending a message to the client device. In an example of step 504, room manager 326 may transmit a message to the client device 306 indicating a meeting is already scheduled in the room, and the client device 306 cannot utilize the room infrastructure (such as the host controller 302, in-room phone, and/or the shared display).

Step 506 includes transmitting a message to the client device listing alternative rooms. In an example of step 506, room manager 326 may analyze a facility-wide calendar (not shown) and transmit a message to the client device 306 including a list of other rooms that are available for immediate use, or use during a future meeting identified in the user meeting packet 320.

Step 508 includes comparing relative priorities of conflicting meetings. In an example of step 508, room manager 326 may further analyze the metadata in user meeting packet 320 to identify user information associated with the user meeting and determine if the user meeting has a higher priority than the pre-scheduled room meeting. For example, the room manager 326 may identify the user meeting has having precedence over a pre-scheduled room meeting when the user meeting includes a C-level or other higher priority attendee. For example, the room manager 326 may identify the user meeting has having precedence over a pre-scheduled room meeting when the user meeting has a higher number of participants (or a greater number of participants than a predetermined threshold). The room manager 326 may also ignore pre-scheduled meetings if the pre-scheduled meeting had previously started, but no activity had occurred on the host controller 302 or shared display associated with the pre-scheduled meeting.

In step 510, method 500 transmits meeting updates to associated participants. For example, when a user meeting did not previously identify a particular room 301 for a given meeting, the room manager 326 (either from the host controller 302 or the server 324) may transmit a meeting update 332 to all participants identified in the user meeting packet 320. Meeting update 332 may have a variety of forms, including email or instant messaging such as SMS, Slack or Microsoft Teams, for example. meeting update 332 may include a variety of content, such as the room location or other identifying information, a start time or other initiation message, and/or connection information (e.g., one or more of dial-in information for the given meeting, and the URL and/or IP address of the host controller 302). The update may automatically change other participants calendars to reflect the room information and associated equipment connection information. Alternatively, the meeting update may be transmitted from the client device 306. Although examples of messages have been given, these are not limiting and other types of information may be sent to meeting participants, managers, or other groups of users such as staff or departments.

Although various examples of resolving conflicts are discussed herein, embodiments are not limited to these examples and other methods are contemplated. In embodiments, method 500 may include additional steps. For example, a user device may detect a condition of a user entering a conferencing room and the user having scheduled a conferencing meeting to automatically display a prompt on the user device requesting input. A prompt may take the form of “Your <Title> meeting is ready, should I start it now?”.

As another example of an additional step, the room infrastructure (e.g., host controller 302) may also transmit the room calendar 328 to the client device 306 such that the user may interact with the client device 306 to schedule meetings in the room. In this way, a user simply needs to connect to the host controller 302, receive the room's calendar 328 and interact to reserve the room 301, and associated equipment.

In embodiments, when a user's device connects to the room, the host controller may display the meeting title that is about to start on the shared display of the room's infrastructure. The host controller may also display metadata about the meeting, for example, “Using Zoom” and “with 5 participants.” This information may also be displayed on the user's device.

In embodiments, connecting a user's device to the room initiates the display of upcoming meetings from the user's calendar that are intended to use a video conferencing room.

In embodiments, a user may connect to a room as described above. If the room has not been booked using the room's calendar, the calendar service may parse the user's calendar entry, automatically book the room on the room's calendar, which may be stored on a server or other database, then email other users who were previously invited to the meeting with a location of the user's room as well as a phone number of the room or other information pertinent to participating in a video conference.

A system and method for enabling flexible, convenient and transparent use of conferencing rooms has been described. A user's device may cooperate with the host controller in a room to assume control of the room and manage a meeting. The method and system provide an advantage that a user is not required to select a room in advance of a meeting or remember to add the room to the meeting notice. The user is also not required to operate a conferencing application specific to the room. Instead, the user may participate in a conference using the familiar environment of the user's device.

### Combinations of Features

Features described above as well as those claimed below may be combined in various ways without departing from the scope hereof. The following enumerated examples illustrate some possible, non-limiting combinations:

(A1) A method of controlling a video conferencing room system comprising a host controller executing a video conferencing room system application to manage video conferencing room infrastructure comprising a camera, a shared display and an audio device, the method including detecting, by a client device, a request to connect to the video conferencing room system; accessing a calendar application on the client device to identify a calendar entry for the video conferencing room system at approximately a time of the request; parsing the identified calendar entry to determine a meeting metadata; sending a user meeting packet comprising the meeting metadata to the host controller; initiating a video conference using the video conferencing room system in accordance with the meeting metadata in the user meeting packet.

(A2) In method (A1), the method of detecting a request to connect to the video conferencing room system includes entering a code associated with the video conferencing room into the client device.

(A3) In any of methods (A1)-(A2), the method of detecting a request to connect to the video conferencing room system includes detecting a presence of a client device in the video conferencing room.

(A4) In any of methods (A1)-(A3), the method of parsing the identified calendar entry further comprises determining meeting metadata in the identified calendar entry.

(A5) In method (A4), the meeting metadata further comprises at least one of meeting title, meeting date, meeting time, meeting organizer, meeting host, meeting participants, meeting members contact information, meeting application and connection requirements.

(A6) In any of methods (A1)-(A5), the method includes transmitting a meeting update to all meeting participants identified in the meeting metadata.

(A7) In any of methods (A1)-(A6), the method of sending the meeting metadata to the host controller includes comparing the meeting metadata with a calendar of the video conferencing room system and resolving conflicts between calendar entries on the client device and calendar entries on the host controller.

(A8) In the method of (A7), the method of resolving conflicts further comprises determining at least one of a user's permission to start a meeting, a permission to use a room, and a priority of meeting types.

(B1) An apparatus for initiating a video conference in accordance with a client calendar entry includes a video conferencing room system comprising: a host controller executing a video conferencing room system application to manage video conference room infrastructure; a camera; a shared display; and an audio device; a client device connected to the video conferencing room system, said client device comprising a processor and a memory storing instructions that when executed by the processor perform the method comprising: detecting, by a client device, a request to connect to the video conferencing room system; accessing a calendar application on the client device to identify a calendar entry for the room at approximately a time of the request; parsing the identified calendar entry to determine meeting metadata; sending a user meeting packet comprising the meeting metadata to the host controller; and initiating a video conference using the video conferencing room system in accordance with the meeting metadata in the user meeting packet.

(B2) In the apparatus of (B1), the host controller further comprises a room manager for receiving the user meeting packet.

(B3) In the apparatus of (B2), the room manager compares the meeting metadata in the user meeting packet with a calendar for the video conferencing room system and resolves scheduling conflicts between a room calendar and one or more meetings identified in the meeting metadata.

(B4) In any of the apparatus of (B1)-(B3), the apparatus includes a plurality of client devices connected to the video conferencing room system.

(C1) A method of automatic initiation of a meeting, in a video conferencing room system, based on a calendar located on a client device, the video conferencing room system comprising a host controller executing a video conferencing room system application to manage video conference room infrastructure comprising a camera, a shared display and an audio device, the method includes connecting the client device to the host controller; accessing a calendar on the client device to identify a calendar entry correspond to a meeting; parsing the calendar entry to identify a meeting metadata; sending a user meeting packet to a room manager; and automatically initiating a video conference using the video conferencing room system in accordance with the meeting metadata in the user meeting packet.

(C2) In method (C1), the method including comparing, using a room manager, the meeting metadata against a room calendar.

(C3) In method (C2), the method including resolving scheduling conflicts between the room calendar and one or more meetings identified in the meeting metadata.

(C4) In method (C3), the method including resolving scheduling conflicts further comprises transmitting a message to the client device indicating the video conferencing room system is booked.

(C5) In any of methods (C2)-(C4), the method including resolving scheduling conflicts further comprises transmitting a message to the client device listing alternative rooms that are available.

(C6) In any of methods (C2)-(C4), the method including resolving scheduling conflicts further comprises comparing relative priorities of the meeting metadata in the user meeting packet and a meeting scheduled in the video conferencing room system.

(C7) In any of methods (C1)-(C6), the method including transmitting a prompt to the client device requesting to initiate the video conference.

(C8) In any of methods (C1)-(C7), the meeting metadata including at least one of meeting title, meeting date, meeting time, meeting organizer, meeting host, meeting participants, meeting members contact information, meeting application and connection requirements.

(C9) In method (C8), the method including transmitting a meeting update to all meeting participants identified in the meeting metadata.

Changes may be made in the above system, methods or device without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A method of controlling a video conferencing room system comprising a host controller executing a video conferencing room system application to manage video conferencing room infrastructure comprising a camera, a shared display and an audio device, the method comprising:
detecting, by a client device, a request to connect to the video conferencing room system;
accessing a calendar application on the client device to identify a calendar entry for the video conferencing room system at approximately a time of the request;
parsing the identified calendar entry to determine a meeting metadata;
sending a user meeting packet comprising the meeting metadata to the host controller; and
initiating a video conference using the video conferencing room system in accordance with the meeting metadata in the user meeting packet.

2. The method of claim 1, wherein the detecting a request to connect to the video conferencing room system further comprises entering a code associated with the video conferencing room into the client device.

3. The method of claim 1, wherein detecting a request to connect to the video conferencing room system further comprises detecting a presence of a client device in the video conferencing room.

4. The method of claim 1, wherein parsing the identified calendar entry further comprises determining meeting metadata in the identified calendar entry.

5. The method of claim 4, wherein the meeting metadata further comprises at least one of meeting title, meeting date, meeting time, meeting organizer, meeting host, meeting participants, meeting members contact information, meeting application and connection requirements.

6. The method of claim 1, further comprising transmitting a meeting update to all meeting participants identified in the meeting metadata.

7. The method of claim 1, wherein sending the meeting metadata to the host controller further comprises:
comparing the meeting metadata with a calendar of the video conferencing room system and
resolving conflicts between calendar entries on the client device and calendar entries on the host controller.

8. The method of claim 7, wherein resolving conflicts further comprises determining at least one of a user's permission to start a meeting, a permission to use a room, and a priority of meeting types.

9. An apparatus for initiating a video conference in accordance with a client calendar entry, comprising:
a video conferencing room system comprising:
a host controller executing a video conferencing room system application to manage video conference room infrastructure;
a camera;
a shared display; and
an audio device;
a client device connected to the video conferencing room system, said client device comprising a processor and a memory storing instructions that when executed by the processor perform the method comprising:
detecting, by a client device, a request to connect to the video conferencing room system;
accessing a calendar application on the client device to identify a calendar entry for the room at approximately a time of the request;
parsing the identified calendar entry to determine meeting metadata;
sending a user meeting packet comprising the meeting metadata to the host controller; and
initiating a video conference using the video conferencing room system in accordance with the meeting metadata in the user meeting packet.

10. The apparatus of claim 9, wherein the host controller further comprises a room manager for receiving the user meeting packet.

11. The apparatus of claim 10, wherein the room manager compares the meeting metadata in the user meeting packet with a calendar for the video conferencing room system and resolves scheduling conflicts between a room calendar and one or more meetings identified in the meeting metadata.

12. The apparatus of claim 9, further comprising a plurality of client devices connected to the video conferencing room system.

13. A method of automatic initiation of a meeting, in a video conferencing room system, based on a calendar located on a client device, the video conferencing room system comprising a host controller executing a video conferencing room system application to manage video conference room infrastructure comprising a camera, a shared display and an audio device, the method comprising:
connecting the client device to the host controller;
accessing a calendar on the client device to identify a calendar entry correspond to a meeting;
parsing the calendar entry to identify a meeting metadata;
sending a user meeting packet to a room manager; and
automatically initiating a video conference using the video conferencing room system in accordance with the meeting metadata in the user meeting packet.

14. The method of claim 13, further comprising comparing, using a room manager, the meeting metadata against a room calendar.

15. The method of claim 14, further comprising resolving scheduling conflicts between the room calendar and one or more meetings identified in the meeting metadata.

16. The method of claim 15, wherein resolving scheduling conflicts further comprises transmitting a message to the client device indicating the video conferencing room system is booked.

17. The method of claim 14, wherein resolving scheduling conflicts further comprises transmitting a message to the client device listing alternative rooms that are available.

18. The method of claim 14, wherein resolving scheduling conflicts further comprises comparing relative priorities of the meeting metadata in the user meeting packet and a meeting scheduled in the video conferencing room system.

19. The method of claim 13, further comprising transmitting a prompt to the client device requesting to initiate the video conference.

20. The method of claim 13, wherein the meeting metadata further comprises at least one of meeting title, meeting date, meeting time, meeting organizer, meeting host, meeting participants, meeting members contact information, meeting application and connection requirements.

21. The method of claim 20, further comprising transmitting a meeting update to all meeting participants identified in the meeting metadata.
